(19) United States
(12) Patent Application Publication
(10) Pub. No.: US 2011/0278268 A1
(43) Pub. Date: Nov. 17, 2011

(54) WRITING AN IMAGE ON FLEXOGRAPHIC MEDIA

(76) Inventors: Alon Siman-Tov, Or Yehuda (IL); Ophira Melamed, Shoham (IL)

(21) Appl. No.: 12/779,131

(22) Filed: May 13, 2010

(51) Int. Cl. B23K 26/38

(52) U.S. Cl. 219/121.69

(57) ABSTRACT

A method writing an image to a surface of a flexible media mounted on a imaging drum includes mounting a flexible media on the imaging drum; scanning the surface of the flexible media with an optical displacement sensor (ODS); providing the scanned data to a microprocessor; providing imaging data to said microprocessor; combining the scanned data and the imaging data; sending the combined data to an imaging head; and imaging said combined data on the flexible media.

### CROSS REFERENCE TO RELATED APPLICATIONS

References is made to commonly-assigned copending U.S. patent application Ser. No. ______ (Attorney Docket No. 96270/NAB), filed herewith, entitled AN IMAGING APPARATUS FOR FLEXOGRAPHIC PRINTING, by Siman-Tov et al., the disclosure of which is incorporated herein.

### FIELD OF THE INVENTION

The present invention relates to methods and apparatus for fixing the unevenness of a flexographic plate by using imaging means.

### BACKGROUND OF THE INVENTION

Flexographic printing involves inking a raised image which then comes in contact with the print substrate, for instance paper or plastic, and the transfer of ink from the raised image onto the print substrate. The plate is made of a rubbery material which has a somewhat pliant nature, the extent of which depends on the smoothness and fragility of the substrate. Contrary to other print processes such as offset lithography and gravure where high pressure is used during ink transfer, it is generally desirable to have a minimum of pressure between the raised inked image on the plate and the substrate. Too little pressure and no ink transfer or very uneven ink transfer will occur. Too much pressure and the pliant surface of the plate will be squashed into the substrate causing blurring of the image edges resulting in poor print quality.

Because of the requirement to work at minimal pressure for optimum quality, the distance between the plate surface and the substrate must be the same over the entire surface. This may depend on the uniformity of the press cylinder on which the plate is mounted, it also depends on the plate thickness uniformity. In the book Flexography Principles and Practices (Fourth Edition, page 109) accuracies of plus or minus 0.0005 inches are needed for the printing plates.

For some years the dominant type of flexographic plates has been based on mixtures of elastomeric material, photosensitive monomers and photoinitiators. Such plates have been termed polymer plates and as such they are supplied to the customer as solid light-sensitive plate material. These plates are generally made to the above mentioned tolerance. For instance, U.S. Pat. No. 4,272,608 (Proskow), describing the manufacture of such plates, states that they can be made by solvent casting or by extruding, calendaring, or pressing at an elevated temperature. A further development in plate technology was in the introduction of LAMS plates-laser ablated masks. A black layer is coated on the photopolymer plate and then ablated away in areas that will correspond to the print image. The plate is exposed to UV light and developed. However accurately the plate is made, there is some distortion due to solvent development. This problem was discussed in U.S. Pat. No. 5,252,432 (Bach et al.). Using suitable choice of photopolymers and developer liquids they were able to achieve a thickness tolerance after development of +/− less than 15 microns.

An alternative way of preparing flexographic plates and sleeves is by engraving with a laser by ablation. Such a process does not require solvent development and therefore changes of thickness from such a cause are eliminated. For sleeves, the flexographic rubber has to be applied to a sleeve shell. U.S. Pat. No. 4,144,812 (Julian) describes such a process and grinding to obtain uniformity of thickness required. Such a method of grinding, however, was discussed in U.S. Pat. No. 5,798,202 (Cushner) as being time consuming and labour intensive.

Flexographic printing has increasing applications in high print quality products which had previously been dominated by gravure and litho printing. For instance, plate-making is much easier and quicker than gravure and the use of inks where the carrying media is evaporated for drying makes it more applicable to printing on polymer than offset litho. The roll-to-roll flexographic machine is simpler than any roll-to-roll offset press which would be needed to print for instance flexible packaging.

For higher quality flexographic printing the plate thickness uniformity becomes an even more important issue. An additional part of obtaining high quality flexo printing is to use a soft under-cushion. During printing this cushion provided the give which would otherwise be provided by the plate image surface which would then slightly distort. However, generally the cushion has an even wider thickness tolerance than the plate itself.

A challenge of all mass production is quality control. For instance, in the case of flexographic plate precursor sheets, mass production is done in a continuous manner and control of thickness must be monitored and adjusted to always be within the specification. There is always some possibility, however, that plate precursor material that will be outside the thickness specification, will escape notice, and reach the customer. Such defects may be visually undetectable and would only be seen once the plate is imaged during the printing process. Whilst the manufacturer may accept responsibility for plate defects and replace any plates, she would be unlikely to recompense the customer for the cost of time, materials, and inconvenience involved. The only way the manufacturer could ensure that this does not happen would be to check each plate precursor in a way that would not be economically viable.

The present invention solves a recognised need to ensure that the customer can optimise plate quality so that they are not wasting time and money in imaging and printing inferior plates. It is possible to reduce the stringency of thickness control in manufacturing with a resulting saving of cost to the customer.

### SUMMARY OF THE INVENTION

Briefly, according to one aspect of the present invention a method for straightening a surface of a flexible media mounted on an imaging drum of an imaging device, is presented. A flexible media is mounted on an imaging drum. The flexible media is scanned by an optical displacement sensor (ODS) and is provided to a microprocessor component in the system controller. The microprocessor combines the data received from the ODS with the data of the image to be imaged on an imaging device. The combined data is sent to the imaging head. The imaging head images the data on the flexible media.

In one embodiment, the flexographic blank is mounted on the imaging cylinder of a laser engraving machine and scanned by an optical displacement sensor (ODS). When the plate contains significant non-uniformity of thickness it is rejected and returned to the manufacturer without the customer spending more time and money on imaging and printing.

When the plate deformities are within certain limitations, an image is then put on the plate and the print areas are ablated to a uniform distance from the plate floor. By this means uniformity of plate thickness can be increased from the manufacturer's specification of +/−12 microns to +/−5 microns. This process can be done even if the plate uniformity conforms to the manufacturer's specification.

In a further embodiment, the image ablation to correct for abnormalities is done before or after the main image ablation. This process is especially effective for plate-on-sleeve and continuous sleeve. This is because the engraving is done on the sleeve that is then mounted on the printing machine, as opposed to plates that are engraved on one cylinder, removed from the cylinder and then mounted on the printing cylinder. It is possible in the case of plate-on sleeve to obtain out-standing thickness uniformity that includes cushion as well as plate thickness differences.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 represents in diagrammatic form the optical displacement sensor (ODS) together with the laser imaging head situated on the imaging carriage;

FIG. 2 represents in diagrammatic form the process of imaging by ablation by using a known method (prior art);

FIG. 3 represents in diagrammatic form the ODS scanning process of a plate secured to the imaging cylinder;

FIG. 4 represents in diagrammatic form the ablation imaging process where both the image and background areas are ablated; and

FIGS. 5a and 5b show in diagrammatic form the plate before imaging and after imaging being ablated and imaged as shown in FIG. 4.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

While the present invention is described in connection with one of the embodiments, it will be understood that it is not intended to limit the invention to this embodiment. On the contrary, it is intended to cover alternatives, modifications, and equivalents as covered by the appended claims.

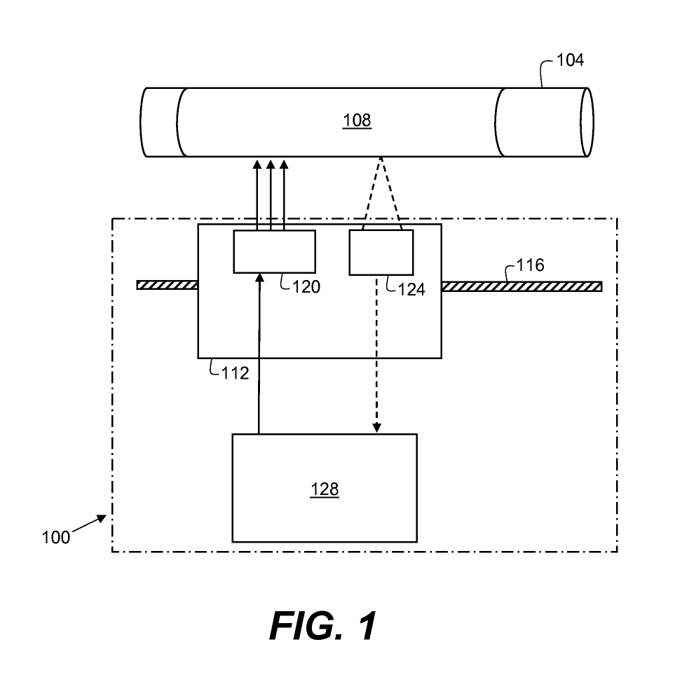

FIG. 1 shows an imaging system 100. The imaging system 100 includes an imaging carriage 112 on which an optical displacement sensor (ODS) 124 is mounted along with an imaging head 120. The ODS 124 is positioned in such a manner that it precedes the imaging during scanning. The imaging head 120 is configured to image on a flexographic plate 108 mounted on a rotating cylinder 104. The carriage 112 is adapted to move substantially in parallel to cylinder 104 guided by an advancement screw 116.

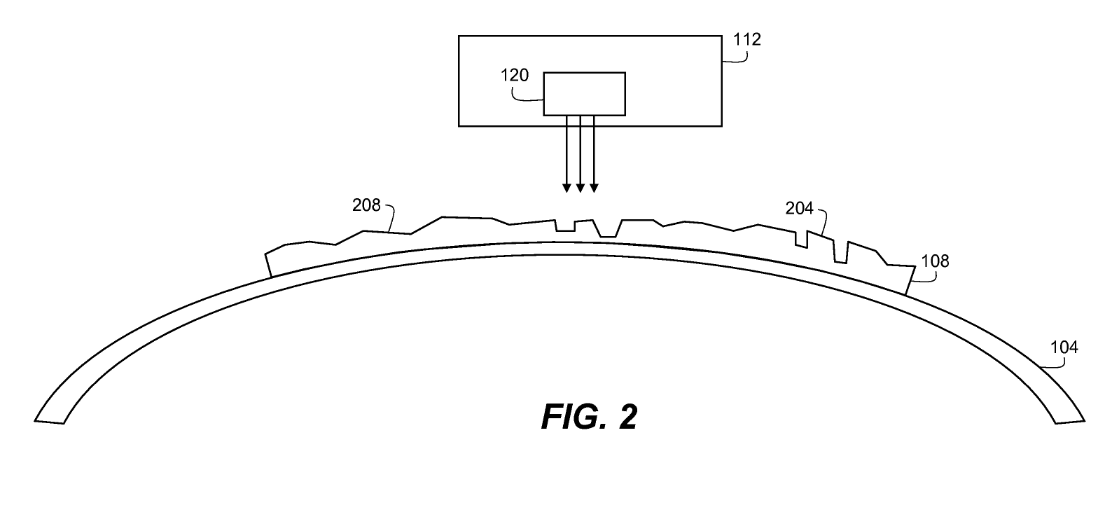

FIG. 2 shows a known imaging method. An imaging head 120 is mounted on a carriage 112 without an ODS. The diagram shows imaging of an ablatable flexographic plate precursor 108 mounted on a cylinder or sleeve 104 (sleeve not shown). In the case where cylinder 104 is a sleeve, it may be one which can be used in the imaging machine and transferred without removal of the imaged plate directly into the flexographic printing press. In this case, the flexographic plate precursor 108 can have been mounted onto the sleeve before imaging and this set-up is known as plate-on-sleeve. Alternatively, the plate material may be integral with the sleeve as a coating and then the set-up may be defined as a sleeve flexographic pre-cursor 108.

The carriage 112 is shown travelling from right to left in a rotary manner in the diagram and where it has been, it has ablated material leaving a protruded image 204. The surface of the non-ablated plate 208 is shown as uneven and FIG. 2 represents the regular method of imaging a plate 108 which may have an uneven surface prior to imaging.

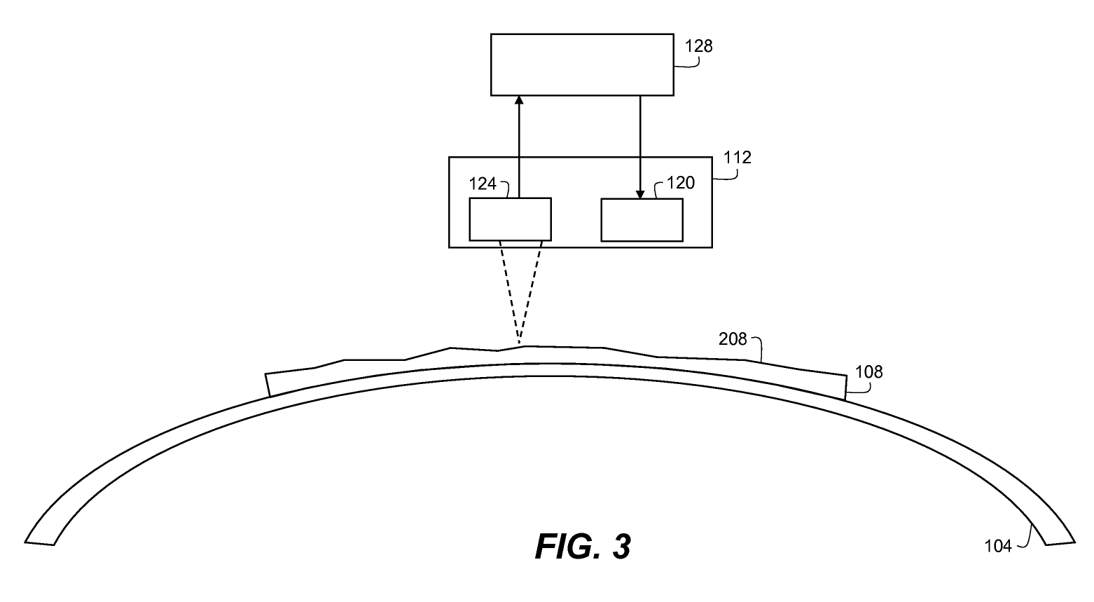

FIG. 3 shows an embodiment wherein the first stage of the imaging process is to scan the flexographic plate 108 with the ODS 124 in order to measure the unevenness of the surface. The ODS 124 is shown scanning the uneven un-imaged flexographic plate 108 with the imaging head 120 inactive (imaging is not performed). The information obtained by the ODS 124 may be used to reject the flexographic precursor plate or sleeve if the material is too uneven for use; or the information may be stored for utilization in one of the alternative embodiments. One alternative is to have a second stage where the information is collected by ODS 124 and is used to ablate the entire surface of the plate to a high degree of evenness. In this embodiment there is a further imaging stage to be performed by the imaging head 120 according to the information previously collected by ODS 124. Another imaging step may follow to image previously evened flexographic plate 108 with alternative may be to first image flexographic plate 108 with imaging information (not shown).

In another embodiment, smoothing the surface of a previously imaged flexographic plate 108 is included. The surface of previously imaged flexographic plate 108 is measured by ODS 124, followed by laser ablation of the surface of the previously imaged flexographic plate 108 with a laser using data collected by ODS 124. This process creates a surface which is uniform in height. Another alternative is to provide the ODS information together with the imaging information to simultaneously produce the imaging together with the ablation correction for surface evenness, or straighten plate 108 surface.

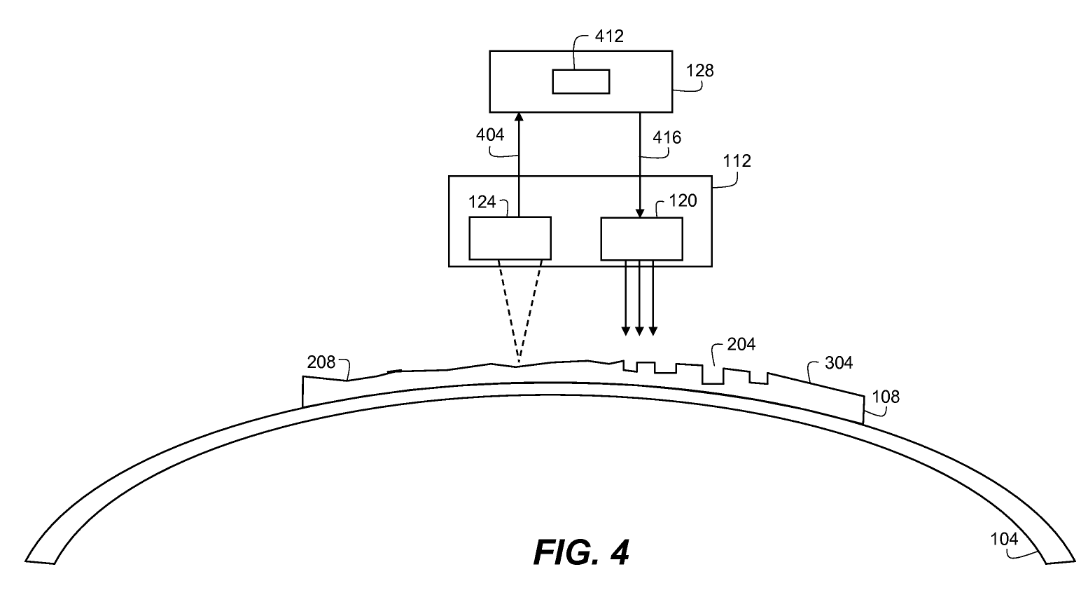

FIG. 4 shows another alternative embodiment. Immediately after placing the sleeve or flexographic plate precursor 108 on the machine, the flexographic plate 108 is scanned and imaged. The ODS 124 measures the unevenness of flexographic plate 108 and during the same scanning operation; the scanned data 404 is combined with the imaging data in microprocessor 412 which is an element in controller 128. The scanned data 404 is collected by ODS 124, and the imaging data is provided by a digital front end station (not shown). The microprocessor 412 analyzes scanned data 404 and imaging data to create combined data 416. Controller 128 then provides the combined data 416 to the imaging head 120 for simultaneously imaging and evening out the surface of the flexographic plate 108. FIG. 4 shows this process, wherein the ODS gathers information, which is fed via the controller 128 into the imaging head 120. The ablated image 204 is shown having been produced on the evened out ablated surface 304 of plate 108 mounted on the cylinder or sleeve 104 (sleeve not shown) which has been inserted into the imaging machine.

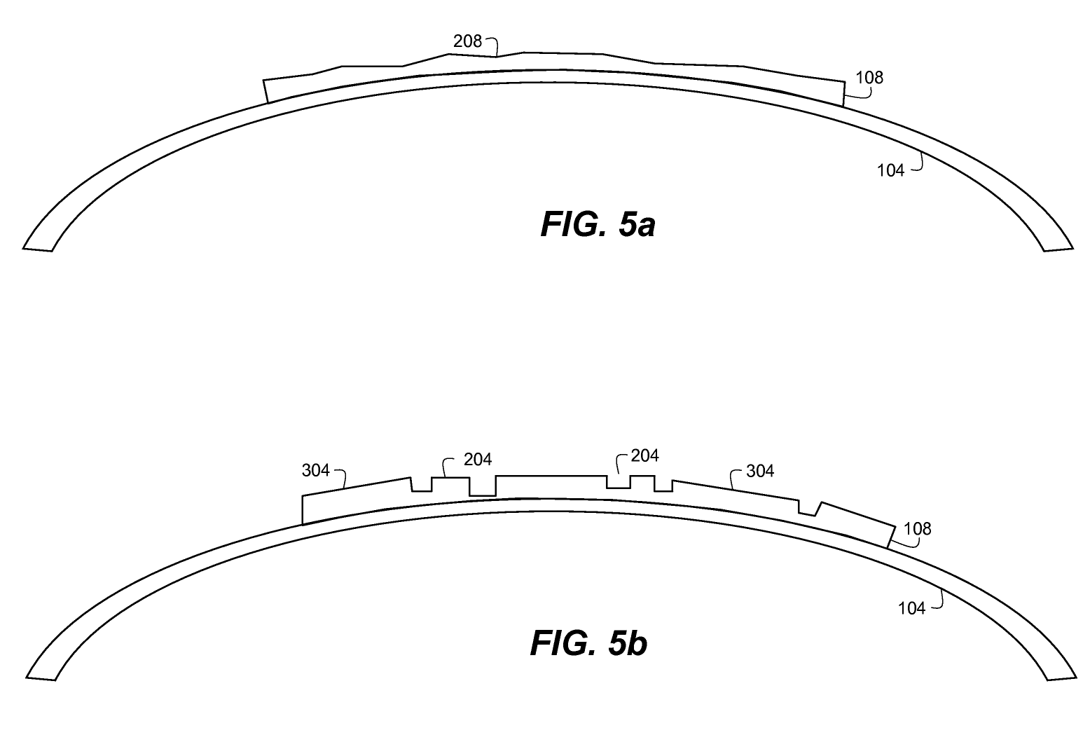

FIGS. 5b and 5a show, respectively, the imaged and evened (204, 304), flexographic plate 108 versus a non-imaged (non even 208) flexographic plate 108 according to the embodiment described in FIG. 4.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

### PARTS LIST

100 imaging system
104 rotating cylinder
108 flexographic plate
112 carriage
116 screw
120 imaging head
124 optical displacement sensor (ODS)
128 controller
204 ablated plate area (printing area)
208 non-ablated plate area (uneven plate)
304 ablated plate surface
404 scanned data
412 microprocessor
416 combined data

1. A method writing an image to a surface of a flexible media mounted on a imaging drum comprising:
mounting the flexible media on said imaging drum;
scanning the surface of said flexible media with an optical displacement sensor (ODS);
transmitting the scanned data to a microprocessor;
combining said scanned data with imaging data;
sending said combined data to an imaging head; and
imaging said combined data on said flexible media.

2. The method according to claim 1 wherein said flexible media is a flexographic plate.

3. The method according to claim 1 wherein said flexible media is a flexographic sleeve.

4. The method according to claim 1 comprising:
adjusting an intensity of a laser on said imaging head according to said combined data prior to imaging said flexible media.

5. The method according to claim 1 wherein said flexible media is previously imaged.

6. The method according to claim 1 comprising:
adjusting a cutting depth of a laser on said imaging head according to said combined data prior to imaging said flexible media.

7. The method according to claim 1 comprising:
ablating the imaged area to a uniform surface height.
